(19) United States
(12) Patent Application Publication
(10) Pub. No.: US 2017/0213228 A1
(43) Pub. Date: Jul. 27, 2017

(54) SYSTEM AND METHOD FOR GROUPED ANALYSIS VIA GEOGRAPHICALLY DISTRIBUTED SERVERS

(71) Applicant: Wal-Mart Stores, Inc., Bentonville, AR (US)

(72) Inventor: Rahul Chowdhury, Rogers, AR (US)

(73) Assignee: Wal-Mart Stores, Inc., Bentonville, AR (US)

(21) Appl. No.: 15/328,822

(22) PCT Filed: Jul. 23, 2015
(86) PCT No.: PCT/US15/41792

§ 371 Date: Jan. 24, 2017

Related U.S. Application Data
(60) Provisional application No. 62/028,568, filed on Jul. 24, 2014.

(51) Int. Cl. G06Q 30/02

(52) U.S. Cl. CPC G06Q 30/0206

(57) ABSTRACT

According to one aspect, embodiments of the invention provide a system for identifying elastic products in a retail environment, the system comprising a network interface configured to be coupled to a communication network, a product analysis module coupled to the network interface and configured to communicate with a server of each one of a plurality of retail stores in the retail environment via the network interface and the communication network, and a database coupled to the product analysis module, wherein the product analysis module is further configured to receive signals from each server of the plurality of retail stores including experience based information related to sales of a plurality of products in each one of the plurality of retail stores, and profile a group of the plurality of products as elastic products based on the experience based information related to the sales of the plurality of products.

### RELATED APPLICATIONS

This application claims priority to U.S. Provisional Application Ser. No. 62/028,568 filed on Jul. 24, 2014, the disclosure of which is incorporated by reference herein in its entirety.

### BACKGROUND OF THE DISCLOSURE

Field of the Invention

Aspects of the present invention relate to a system and method for identifying “elastic” products in a retail environment.

Discussion of Related Art

The sales of some products sold in a retail environment are affected by the price of the products. Such products are typically referred to as “elastic” products in that the sales of such products are affected by (or elastic to) price adjustments (e.g., a markdown). A markdown is a reduction in the selling price of an item which is intended to stimulate or drive consumers to purchase higher quantities of the item, thus increasing profit. The sales of other products sold in a retail environment are not affected by price adjustments. Such products are referred to as “inelastic” products in that the sales of such products are not affected by (or inelastic to) price adjustments (e.g., markdowns), regardless of the time and/or level of the price adjustment.

### SUMMARY

Embodiments described herein provide a system and method for analyzing and identifying “elastic” products in a retail environment. As defined herein, a product for sale in a retail environment is classified as an “elastic” product when the sales of the product are affected by (or elastic to) a price adjustment. Embodiments described herein provide a system and method for quickly and accurately identifying elastic products sold in a retail environment utilizing actual “experience based” information. As defined herein, “experience based” information includes actual (past and/or current) sales information of a product and/or product information associated with sales (past or current) of a product, as opposed to forecasted or future sales or product information.

After a group of elastic products is identified, according to one embodiment sales and/or product information related to the group of elastic products may be analyzed to generate normalized elasticity values for the elastic products. The normalized elasticity values may assist a person in making decisions regarding price adjustments corresponding to the group of elastic products. By examining the normalized elasticity values across the retail environment, a price decision maker for a store (e.g., a manager) may be able to quickly analyze how the current price and/or monthly sales of an elastic product in the store compare to the price and/or sales of the product across the retail environment and make appropriate price decisions based on the analysis.

According to at least one embodiment described herein, a system that is a tool for managers or price decision makers of a retail environment (including multiple retail outlets) to accurately and efficiently identify elastic products in the retail environment and perform real-time elasticity analysis on the identified elastic products. The tool automatically compiles experience based sales and product information from a server at each retail outlet within the retail environment and analyzes the retrieved information to identify a group of elastic products for sale in the retail environment. In at least one embodiment, upon identifying the group of elastic products, the tool also generates normalized elasticity values for each elastic product and provides the normalized elasticity values to the manager (e.g., as an elasticity curve). The normalized elasticity values may assist the manager in making decisions regarding price adjustments corresponding to the group of elastic products. By examining the normalized elasticity values across the retail environment, the manager for a store may be able to quickly analyze how the current price and/or monthly sales of an elastic product in the store compare to the price and/or sales of the product across the retail environment and make appropriate price decisions based on the analysis.

One aspect of the present invention is directed to a system for identifying elastic products in a retail environment, the system comprising a network interface configured to be coupled to a communication network, a product analysis module coupled to the network interface and configured to communicate with a server of each one of a plurality of retail stores in the retail environment via the network interface and the communication network, and a database coupled to the product analysis module, wherein the product analysis module is further configured to receive signals from each server of the plurality of retail stores including experience based information related to sales of a plurality of products in each one of the plurality of retail stores, and profile a group of the plurality of products as elastic products based on the experience based information related to the sales of the plurality of products.

According to one embodiment, in profiling the group of the plurality of products as elastic products, the product analysis module is further configured to generate a ranking of the plurality of products based on sales of the plurality of products. In one embodiment, in profiling the group of the plurality of products as elastic products, the product analysis module is further configured to filter the ranking of the plurality of products into a first group of highest selling products. In another embodiment, in profiling the group of the plurality of products as elastic products, the product analysis module is further configured to determine a weekday-to-weekend sales skew for each product in the first group of highest selling products. In one embodiment, in profiling the group of the plurality of products as elastic products, the product analysis module is further configured to filter the first group of highest selling products into a second group of elastic products based on the weekday-to-weekend sales skews of the first group of highest selling products.

According to another embodiment, the product analysis module is further configured to calculate a normalized elasticity value for each one of the group of profiled elastic products, at each one of the plurality of stores, based on a monthly sales average of each one of the group of profiled elastic products across the plurality of retail stores. In one embodiment, the calculated normalized elasticity values include at least one of a price based normalized elasticity value and a sales quantity based normalized elasticity value. In another embodiment, the product analysis module is further configured to generate at least one elasticity curve including the normalized elasticity values of at least one of the group of profiled elastic product across the plurality of retail stores. In one embodiment, the product analysis module is further configured to provide at least one of the profiled group of elastic products and the at least one elasticity curve to an interface in communication with the product analysis module.

Another aspect of the present invention is directed to a method for identifying elastic products in a retail environment including a plurality of retail stores, each retail store including a server, the method comprising acts of receiving, with a product analysis module via a network interface, signals from each server of the plurality of retail stores including experience based information related to sales of a plurality of products in each one of the plurality of retail stores, and profiling a group of the plurality of products as elastic products based on the experience based information related to the sales of the plurality of products.

According to one embodiment, the act of profiling the group of the plurality of products as elastic products includes ranking the plurality of products based on sales of the plurality of products. In one embodiment, the act of profiling the group of the plurality of products as elastic products includes filtering the ranking of the plurality of products into a first group of highest selling products. In another embodiment, the act of profiling the group of the plurality of products as elastic products includes determining a weekday-to-weekend sales skew for each product in the first group of highest selling products. In one embodiment, the act of profiling the group of the plurality of products as elastic products includes filtering the first group of highest selling products into a second group of elastic products based on the weekday-to-weekend sales skews of the first group of highest selling products.

According to another embodiment, the method further comprises an act of calculating a normalized elasticity value for each one of the group of profiled elastic products, at each one of the plurality of stores, based on a monthly sales average of each one of the group of profiled elastic products across the plurality of retail stores. In one embodiment, the method further comprises an act of generating at least one elasticity curve including the normalized elasticity values of at least one of the group of profiled elastic product across the plurality of retail stores. In another embodiment, the method further comprises an act of displaying at least one of the profiled group of elastic products and the at least one elasticity curve to a user of the product analysis module. In one embodiment, the acts of receiving and profiling are performed in real time.

At least one aspect of the present invention is directed to a non-transitory computer-readable medium encoded with instructions for execution on a distributed computer system within a retail environment, the instructions when executed, performing a method comprising acts of receiving, with a product analysis module via a network interface, signals from each server of the plurality of retail stores including experience based information related to sales of a plurality of products in each one of the plurality of retail stores, and profiling a group of the plurality of products as elastic products based on the experience based information related to the sales of the plurality of products.

According to one embodiment, the method further comprises an act of calculating a normalized elasticity value for each one of the group of profiled elastic products, at each one of the plurality of stores, based on a monthly sales average of each one of the group of profiled elastic products across the plurality of retail stores.

### BRIEF DESCRIPTION OF DRAWINGS

The accompanying drawings are not intended to be drawn to scale. In the drawings, each identical or nearly identical component that is illustrated in various FIGs. is represented by a like numeral. For purposes of clarity, not every component may be labeled in every drawing. In the drawings:

FIG. 1 is a block diagram illustrating a system for identifying elastic products in a retail environment in accordance with at least one embodiment described herein;

FIG. 2 is a flow chart illustrating a process for identifying elastic products in a retail environment in accordance with at least one embodiment described herein;

FIG. 3 is a block diagram of a general-purpose computer system upon which various embodiments of the invention may be implemented; and

FIG. 4 is a block diagram of a computer data storage system with which various embodiments of the invention may be practiced.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Exemplary embodiments provide a novel and effective way of improving the efficiency of data analytics by automatically narrowing the amount of items with high elasticity and automatically adjusting the prices of those products. The system and method provide a technical improvement by reducing amount of work needed to be done by the server and database by providing the functionality of automatically narrowing down products with high price elasticity and adjusting the price of the product accordingly rather than determining the price elasticity for each product separately. This functionality reduces the amount of data needed to be processed by the server and amount of calls to the database.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

As discussed above, elastic product sales are affected by price adjustments. Accordingly, retailers commonly utilize markdowns or other types of price adjustments to drive the sales of such elastic products. However, in a retail environment where thousands, if not millions, of products are sold, it is oftentimes difficult to identify which products are elastic, forecast the impact of any price adjustments, and/or determine the magnitude of any desired price adjustments. For example, there are oftentimes so many factors involved in the sale of products within a retail environment that accurate and efficient mathematical modeling of the retail environment, or even a certain product within the retail environment, can be overly burdensome and/or inaccurate.

Accordingly, embodiments described herein provide a system and method for accurately and efficiently identifying elastic products sold in a retail environment utilizing experience based profiling. After elastic products are identified, sales and/or product information related to the elastic products may be analyzed to generate normalized elasticity values for the elastic products. The normalized elasticity values may assist a person in making decisions regarding the price of the elastic products.

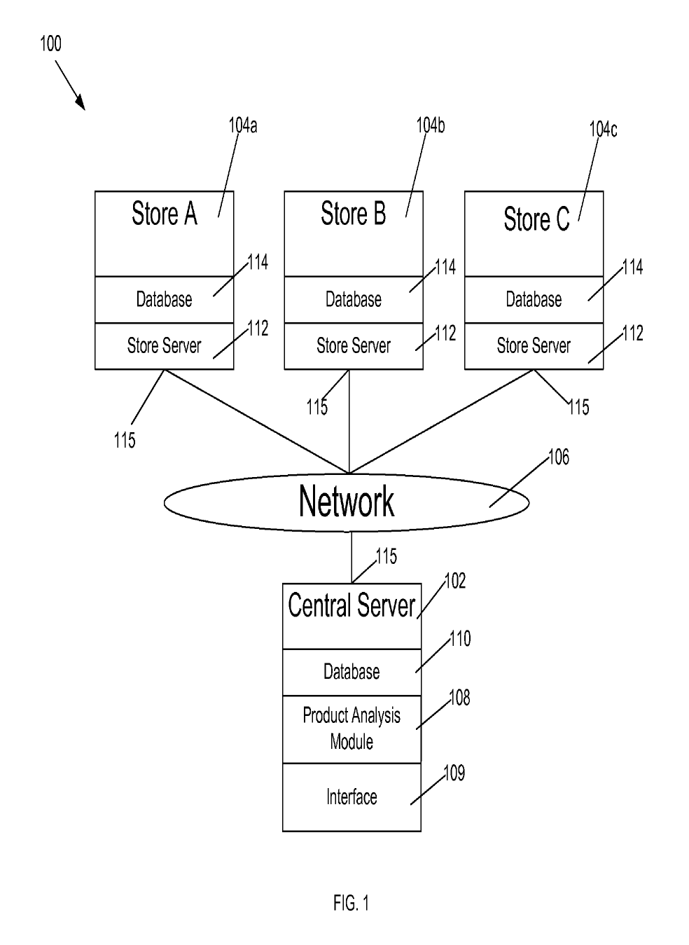

FIG. 1 illustrates one embodiment of a system 100 for identifying elastic products in a retail environment. The system 100 includes a central server 102, a group of retail stores 104(a-c), and a network 106. The central server 102 includes a product analysis module 108 and a database 110. Each retail store 104(a-c) includes a store server 112 and a database 114.

Within each store 104(a-c), the store server 112 is configured to communicate with different store systems (e.g., a Point of Sale (POS) system, a store fulfillment system, an administration system, an inventory management system, etc.) to gather experience based information related to the products offered for sale in the store and to the actual sales of products within the store. For example, according to some embodiments, the store server 112 within each store 104(a-c) gathers information from the different store systems related to the identification of different products sold within the store, the total number of units sold of each type of product offered for sale within the store over a given period of time, the current price for each product sold within the store, the total sales (in dollars) of each type of product offered for sale within the store over a given period of time, and other experience based information related to the products offered for sale within the store and/or the sales of the products within the store (e.g., the identification of the days of the week on which the sales of the products occur). In other embodiments, any other type of information which is related to the products offered for sale within the store and/or the actual sales of the products within the store may be gathered.

According to one embodiment, the store server 112 communicates with the different store systems via a Local Area Network (LAN). The store server 112 may communicate with the different store systems wirelessly or via a hardwired connection. The store server 112 maintains the gathered product and sales information in the database 114.

The product analysis module 108 within the central server 102 communicates with the store server 112 of each store 104(a-c) to retrieve desired information from the database 114 of each store 104(a-c) related to the products offered for sale within the store and the actual sales of the products within the store (as discussed above). According to one embodiment (as illustrated in FIG. 1), the product analysis module 108 is located externally from the retail stores 104(a-c) (e.g., within the central server 102 at a corporate headquarters or some other operations center). In such an embodiment, the product analysis module 108 (within the central server 102) communicates with the store server 112 of each store 104(a-c) via the network 106 and network interfaces 115 at the central server 102 and the store servers 112. According to one embodiment, the network 106 is the Internet; however, in other embodiments, the network 106 may be some other type of Wide Area Network (WAN) or group of networks. Also, it should be appreciated that one or more functions as described herein may be performed by one or more services distributed among one or more systems.

In another embodiment, the product analysis module 108 is located within one of the group of retail stores 104(a-c). For example, the product analysis module may be located within the store server 112 of one of the retail stores 104a. In such an embodiment, the product analysis module 108 may communicate with the database 114 of the store 104a within which it is located (and any other necessary store systems) via a LAN. The product analysis module 108 may also communicate with the store servers 108 of each other store 104(b-c) via the network 106 and network interfaces 115 (as discussed above).

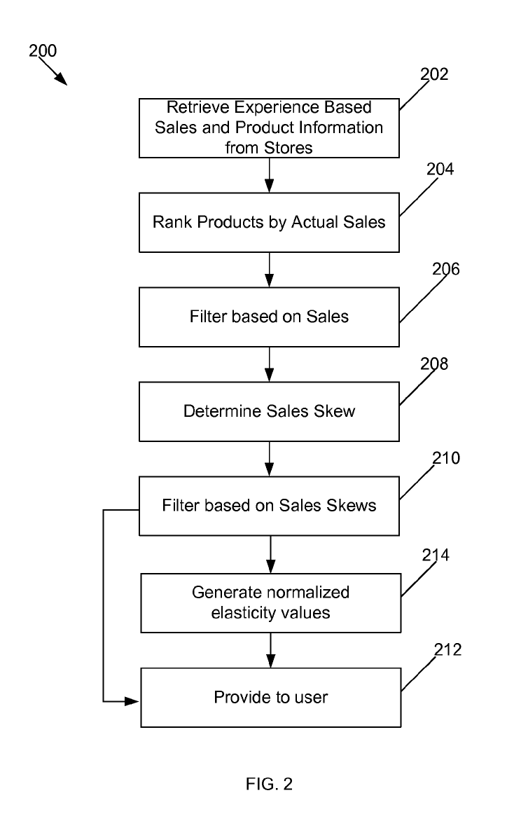

Upon retrieving the desired experience based product and sales information (related to the retail stores 104(a-c)), the product analysis module 108 analyzes the retrieved experience based information to identify elastic products for sale in the retail environment. In some embodiments, upon identifying elastic products, the product analysis module 108 further analyzes the retrieved experience based information to generate normalized elasticity values for the identified elastic products. The normalized elasticity values may assist a person in making decisions regarding the price of the elastic products. Operation of the product analysis module 108 is discussed in greater detail below with regard to FIG. 2.

FIG. 2 is a flow chart illustrating a process for identifying elastic products in a retail environment in accordance with at least one embodiment. At block 202, the product analysis module 108 retrieves desired experience based information from the database 114 of each store 104(a-c) related to the products offered for sale within each store and the actual sales of the products within each store. For example, in at least one embodiment, the experience based sales and product information retrieved from the different stores related to the identification of different products sold within each store, the total number of units sold of each type of product offered for sale within each store over a given time period, the current price for each product sold within each store, the total sales (in dollars) of each type of product offered for sale within each store over a given time period, and other experience based information related to the products offered for sale within each store and/or the sales of the products within each store (e.g., the identification of the days of the week on which the sales of the products have occurred). In other embodiments, any other type of information which is related to the products offered for sale within each store and/or the actual sales of the products within each store may be retrieved.

At block 204, the product analysis module 108 ranks the products for which it has received corresponding information to identify high selling products in the retail environment. Applicant has appreciated that higher selling products are more visible to customers and therefore are more known to customers. Products that are more known to customers tend to be price sensitive as customers see the products and corresponding prices more often and therefore are more aware of price adjustments and are more likely to have their purchasing decisions impacted by a price adjustment. In one embodiment, the product analysis module 108 ranks the products by sales volume over a period of time. In another embodiment, the product analysis module 108 ranks the products by sales revenue over a period of time.

According to one embodiment, the product analysis module 108 ranks products, by actual sales, across the entire retail environment; however, in another embodiments, the product analysis module 108 may rank products within smaller groupings. For example, in one embodiment, the product analysis module 108 ranks products by store. In another embodiment, the product analysis module 108 ranks products by department. In another embodiment, the product analysis module 108 ranks products by category. In other embodiments, the product analysis module 108 may rank products in any other appropriate way to identify desired high selling products.

At block 206, based on the sales ranking of products generated at block 204, the product analysis module 108 filters out a first group of the highest selling products from the ranking. For example, in one embodiment, the product analysis module 108 identifies products that, for a prior period of time, had sales volume greater than a sales volume threshold. In another embodiment, the product analysis module 108 identifies products that, for a prior period of time, had sales revenue greater than a sales revenue threshold. In another embodiment, the product analysis module 108 identifies products that are in a top percentage (e.g., top 10%) of the sales ranking. In other embodiments, the product analysis module 108 may be configured to filter out a first group of the highest selling products based on some other appropriate parameter.

At block 208, the product analysis module 108 determines a sales skew of each product within the first group of filtered products identified at block 206. Applicant has appreciated that a relatively large variation in sales of a product (i.e., a relatively large sales skew) between certain days may indicate that the product is elastic. For example, applicant has appreciated that customers are typically price sensitive for products for which they can wait and customers typically shop for items for which they can wait on the weekends. That is to say, customers are typically willing to wait until the weekend to buy not so urgent, but needed, products. Accordingly, if a product sells more on weekend days than weekdays, it is a good indication that a customer is price sensitive to the product (i.e., is willing to wait for a price adjustment to buy the product) and that the product is elastic. Therefore, in one embodiment, at block 208, the product analysis module 108 determines a sales skew between weekday and weekend sales of each product within the first group of filtered products identified at block 206.

At block 210, based on the weekday/weekend sales skews determined at block 208, the product analysis module 108 filters out a second group of products, from the first group of products, having greater weekend sales than weekday sales and having the highest weekday/weekend sales skews. For example, in one embodiment, the product analysis module 108 identifies products that have greater weekend sales than weekday sales and have a weekday/weekend sales skew that is greater than a sales skew threshold. In another embodiment, the product analysis module 108 identifies products that have greater weekend sales than weekday sales and have a weekday/weekend sales skew that is in a top percentage (e.g., the top 10%) of the sales skews of the products in the first group. In other embodiments, the product analysis module 108 may be configured to filter out a second group of products, from the first group of products, having greater weekend sales than weekday sales and the highest weekday/weekend sales skews based on some other appropriate parameter.

At block 212, the second group of products is provided by the product analysis module 108 to a user of the system 100 as a group of identified elastic products. The second group of products may be provided to an interface 109 coupled to, or in communication with, the central server 102. The interface 109 may be a display, a printer, or some other interface capable of providing the second group of products to the user.

By filtering products based on experience based information (e.g., such as actual sales and product based information as discussed above), a group of elastic products from across an entire retail environment may be quickly and accurately identified. Also, by utilizing a mutually exclusive dual filtering process (e.g., based on both the highest selling products and the products with the highest weekend to weekday sales skews as discussed above), multilayered filtration is provided which may increase the accuracy of the identified group of elastic products.

According to one embodiment, prior to providing information to the user, at block 214 the product analysis module 108 generates a normalized elasticity value for each one of the second group of products at each associated store. In one embodiment, the normalized elasticity value is a normalized price value. For example, the current price of each product identified in the second group of products, at each associated store, may be normalized to a geometric range around 1 by dividing each current price by a monthly average of the price of the corresponding product from across the retail environment. If a product in the second group of products is currently for sale at an associated store for a price equal to the monthly average, that product will have a normalized elasticity value of 1. If a product in the second group of products is currently for sale at an associated store for a price less than the monthly average, that product will have a normalized elasticity value less than 1. If a product in the second group of products is currently for sale at an associated store for a price greater than the monthly average, that product will have a normalized elasticity value greater than 1.

According to another embodiment, the normalized elasticity value is a normalized quantity sold value. For example, the number of units sold of each product in the second group of products, at each associated store, per month may be normalized to a geometric range around 1 by dividing the number of units sold per month of each product, at each associated store by a monthly average of the number of units sold of the corresponding product from across the retail environment. If a product in the second group of products has been sold at an associated store a number of times equal to the monthly average, that product will have a normalized elasticity value of 1. If a product in the second group of products has been sold at an associated store a number of times less than the monthly average, that product will have a normalized elasticity value less than 1. If a product in the second group of products has been sold at an associated store a number of times more than the monthly average, that product will have a normalized elasticity value greater than 1. In some embodiments, the product analysis module 108 may calculate multiple normalized elasticity values (e.g., based on price and quantity sold) per product at each store.

Applicant has appreciated that by normalizing the price and/or quantity sold of each product in the second group of products in relation to a monthly average, the effects of different store variables (e.g., seasonality, size, local customs, etc) on the elasticity analysis of each product may be reduced.

At block 212, the calculated normalized elasticity values (e.g., related to price and/or quantity) are provided by the product analysis module 108 to a user of the system 100. The calculated normalized elasticity values may be provided to an interface 109 coupled to, or in communication with, the central server 102. The interface 109 may be a display, a printer, or some other interface capable of providing the second group of products to the user. In one embodiment, the calculated normalized elasticity values provided to the user are included in an elasticity curve that displays the normalized elasticity value of an associated elastic product at each store across the retail environment (or at a desired group of stores across the retail environment).

By examining the elasticity curve, a user (e.g., a price decision maker, manager, or other user type) at a store may be able to quickly analyze how the current price and/or monthly sales of an elastic product in the store compare to the price and/or sales of the product across the retail environment. Utilizing this information, the price decision maker can quickly and easily identify where price adjustments may be desired. For example, if upon viewing the elasticity curve, the user sees that an elastic product for sale in the corresponding store has a normalized elasticity value (based on price) less than 1 and a normalized elasticity value (based on quantity sold) greater than 1, the user may determine that the price of the product at the corresponding store may be increased to bring the price more in line with the monthly price average and a resulting reduction in units sold will be acceptable as the current monthly sales are already greater than the monthly average of units sold. Similarly, if upon viewing the elasticity curve, the user sees that an elastic product for sale in the corresponding store has a normalized elasticity value (based on price) greater than 1 and a normalized elasticity value (based on quantity) less than 1, the user may determine that the price of the product at the corresponding store may be decreased to bring the price more in line with the monthly price average and to drive an increase in monthly sales of the product.

Various embodiments according to the present invention may be implemented on one or more computer systems or other devices. A computer system may be a single computer that may include a minicomputer, a mainframe, a server, a personal computer, or combination thereof. The computer system may include any type of system capable of performing remote computing operations (e.g., cell phone, PDA, tablet, smart-phone, set-top box, or other system). A computer system used to run the operation may also include any combination of computer system types that cooperate to accomplish system-level tasks. Multiple computer systems may also be used to run the operation. The computer system also may include input or output devices, displays, or data storage units. It should be appreciated that any computer system or systems may be used, and the invention is not limited to any number, type, or configuration of computer systems.

These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate operation of the described system according to various embodiments of the invention. Further, the system may be located on a single computer or may be distributed among a plurality of computers attached by a communications network.

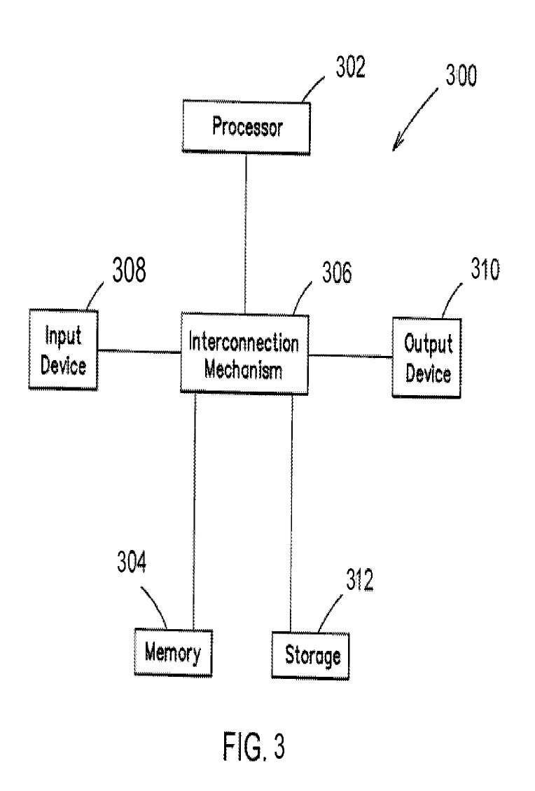

For example, various aspects of the invention may be implemented as specialized software executing in a general-purpose computer system 300 such as that shown in FIG. 3. The computer system 300 may include a processor 302 connected to one or more memory devices (i.e., data storage) 304, such as a disk drive, memory, or other device for storing data. Memory 304 is typically used for storing programs and data during operation of the computer system 300. Components of computer system 300 may be coupled by an interconnection mechanism 306, which may include one or more busses (e.g., between components that are integrated within a same machine) and/or a network (e.g., between components that reside on separate discrete machines). The interconnection mechanism 306 enables communications (e.g., data, instructions) to be exchanged between system components of system 300. Computer system 300 also includes one or more input devices 308, for example, a keyboard, mouse, trackball, microphone, touch screen, and one or more output devices 310, for example, a printing device, display screen, and/or speaker. In addition, computer system 300 may contain one or more interfaces that connect computer system 300 to a communication network (in addition or as an alternative to the interconnection mechanism 306).

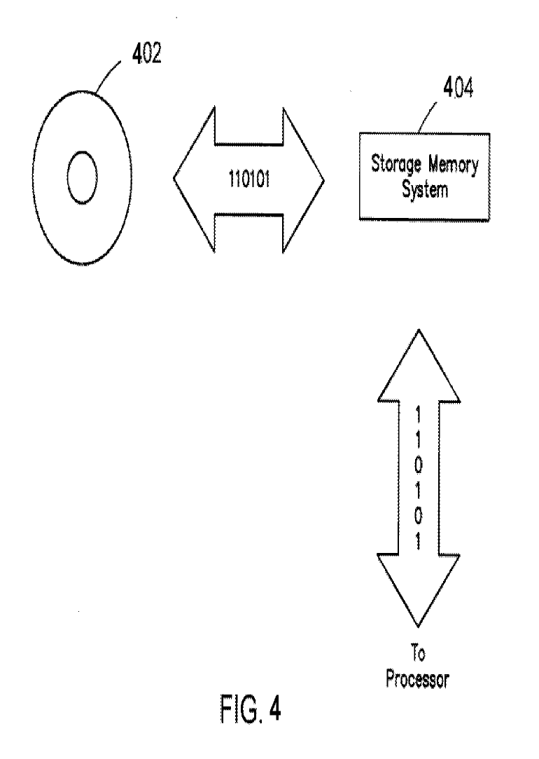

The storage system 312, shown in greater detail in FIG. 4, typically includes a computer readable and writeable nonvolatile recording medium 402 in which signals are stored that define a program to be executed by the processor or information stored on or in the medium 402 to be processed by the program. The medium may, for example, be a disk or flash memory. Typically, in operation, the processor causes data to be read from the nonvolatile recording medium 402 into another memory 404 that allows for faster access to the information by the processor than does the medium 402. This memory 404 is typically a volatile, random access memory such as a dynamic random access memory (DRAM) or static memory (SRAM). It may be located in storage system 312, as shown, or in memory system 304. The processor 302 generally manipulates the data within the integrated circuit memory 304, 404 and then copies the data to the medium 402 after processing is completed. A variety of mechanisms are known for managing data movement between the medium 402 and the integrated circuit memory element 304, 404, and the invention is not limited thereto. The invention is not limited to a particular memory system 304 or storage system 312. The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component. Although computer system 300 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architecture or components that that shown in FIG. 3.

Computer system 300 may be a general-purpose computer system that is programmable using a high-level computer programming language. Computer system 300 may be also implemented using specially programmed, special purpose hardware. In computer system 300, processor 302 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP, Windows Visa, Windows 7, or Windows 8 operating systems available from the Microsoft Corporation, MAC OS System X operating system or an iOS operating system available from Apple Computer, one of many Linux-based operating system distributions, for example, the Enterprise Linus operating system available from Red Hat Inc., or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol. Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

As described above, the calculated normalized elastic values are provided to the user in an elasticity curve; however, in other embodiments, the calculated normalized elastic values may be provided to the user in any other appropriate format.

As also described above, a dual filtering process based on experience based information is utilized to identify a group of elastic products; however, in other embodiments, the filtering process may include less than or more than two filtering steps and the filtering steps may be performed based on any appropriate experience based information related to identifying whether a product is elastic.

As described above, price and/or quantity sold information is normalized to a geometric range around 1; however, in other embodiments, the normalized values may be defined differently.

According to one embodiment, the product analysis module 108 is configured to receive sales and/or product information from the store servers 112, update the identification of elastic products, and update the calculation of normalized elasticity values in real time. In another embodiment, the product analysis module 108 is configured to receive sales and/or product information from the store servers 112, update the identification of elastic products, and update the calculation of normalized elasticity values at predetermined intervals.

As discussed above, it is oftentimes difficult for a price decision maker in a retail environment to quickly and accurately identify which products, out of all products sold in the retail environment, are elastic. Accordingly, embodiments described herein provide a system and method for quickly and accurately identifying elastic products sold in a retail environment utilizing experience based information (e.g., such as actual sales and/or product information).

After a group of elastic products is identified, sales and/or product information related to the group of elastic products may be further analyzed to generate normalized elasticity values for the elastic products. The normalized elasticity values may assist a person in making decisions regarding price adjustments corresponding to the group of elastic products. By examining the normalized elasticity values across the retail environment, a price decision maker for a store may be able to quickly analyze how the current price and/or monthly sales of an elastic product in the store compare to the price and/or sales of the product across the retail environment and make appropriate price decisions based on the analysis.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for comprising:
a network interface configured to be coupled to a communication network;
a analysis module coupled to the network interface and configured to communicate with each one of a plurality of servers via the network interface and the communication network; and
a database coupled to the analysis module;
wherein the analysis module is further configured to:
receive signals from each of the plurality of servers including experience based information associated with a plurality of products previously co-located with each one of the servers; and
profile a group of the plurality of products as having elastic attributes based on the experience based information associated with the plurality of products.

2. The system of claim 1, wherein in profiling the group of the plurality of products as having elastic attributes, the analysis module is further configured to generate a ranking of the plurality of products based on experience based information.

3. The system of claim 2, wherein in profiling the group of the plurality of products, the analysis module is further configured to filter the ranking of the plurality of products into a first group based on a first parameter of the experience based information associated with the plurality of products.

4. The system of claim 3, wherein in profiling the group of the plurality of products, the analysis module is further configured to determine a variation in data from weekday-to-weekend for each product in the first group of products.

5. The system of claim 4, wherein in profiling the group of the plurality of products, the analysis module is further configured to filter the first group products into a second group based on the variation in data from weekday-to-weekend of the first group of products.

6. The system of claim 1, wherein the analysis module is further configured to calculate a normalized elasticity value for the group, based on data associated with a the group.

7. The system of claim 6, wherein the calculated normalized elasticity values include at least one of a value based normalized elasticity value and a quantity based normalized elasticity value.

8. The system of claim 6, wherein the analysis module is further configured to generate at least one elasticity curve including the normalized elasticity values of the group.

9. The system of claim 8, wherein the analysis module is further configured to provide the group and the at least one elasticity curve to an interface in communication with the analysis module.

10. A method comprising:
receiving, with a analysis module via a network interface, signals from each one of a plurality of servers including experience based information associated with a plurality of products previously co-located with each of the servers; and
profiling a group of the plurality of products as having elastic attributes based on the experience based information.

11. The method of claim 10, wherein the act of profiling the group includes ranking the plurality of products based on experience based information associated with the plurality of products.

12. The method of claim 11, wherein the act of profiling the group includes filtering the ranking of the plurality of products into a first group based on a first parameter of the experience based information.

13. The method of claim 12, wherein the act of profiling the group includes determining a variation in data from weekday-to-weekend for each product in the first group.

14. The method of claim 13, wherein the act of profiling the group includes filtering the first group of products into a second group based on the variation in data from weekday-to-weekend for each product in the first group.

15. The method of claim 10, wherein the method further comprises calculating a normalized elasticity value for the group based on data associated with the group of profiled elastic products.

16. The method of claim 15, wherein the method further comprises generating at least one elasticity curve including the normalized elasticity values of the group.

17. The method of claim 16, wherein the method further comprises displaying the group and the at least one elasticity curve to a user of the analysis module.

18. The method of claim 10, wherein the acts of receiving and profiling are performed in real time.

19. A non-transitory computer-readable medium encoded with instructions for execution on a distributed computer system, the instructions when executed, performing a method comprising:
receiving, with a analysis module via a network interface, signals from each one of a plurality of servers including experience based information associated with a plurality of products previously co-located with each of the servers; and
profiling a group of the plurality of products as having elastic attributes based on the experience based information associated with the plurality of products.

20. The non-transitory computer-readable medium of claim 19, wherein the method further comprises calculating a normalized elasticity value for the group based on data associated with the group.
